(19) United States
(12) Patent Application Publication
(10) Pub. No.: US 2016/0358382 A1
(43) Pub. Date: Dec. 8, 2016

(54) Augmented Reality Using 3D Depth Sensor and 3D Projection

(71) Applicant: VanGogh Imaging, Inc., McLean, VA (US)

(72) Inventors: Ken Lee, Fairfax, VA (US); Xin Hou, Herndon, VA (US)

(21) Appl. No.: 15/172,723

(22) Filed: Jun. 3, 2016

Related U.S. Application Data
(60) Provisional application No. 62/170,910, filed on Jun. 4, 2015.

(51) Int. Cl. G06T 19/00; H04N 9/31; G06T 11/60; H04N 13/02; G06T 17/00

(52) U.S. Cl. CPC G06T 19/006; H04N 13/0246; G06T 17/00; G06T 11/60; H04N 9/31

(57) ABSTRACT

Described herein are methods and systems for augmented reality in real-time using real-time 3D depth sensor and 3D projection techniques. A 3D sensor coupled to a computing device captures one or more scans of a physical object in a scene. The computing device generates a 3D model of the physical object based upon the one or more scans. The computing device determines a pose of the 3D model relative to a projector at the scene and predistorts image content based upon the pose of the 3D model to generate a rendered image map. A projector coupled to the computing device superimposes the rendered image map onto the physical object in the scene.

### RELATED APPLICATIONS

This application claims priority to U.S. Provisional Patent Application No. 62/170,910, filed on Jun. 4, 2015.

### TECHNICAL FIELD

The subject matter of this application relates generally to methods and apparatuses, including computer program products, for augmented reality in real-time using three-dimensional (3D) depth sensor and 3D projection techniques.

### BACKGROUND

There is a great deal of interest in providing immersive experience using virtual reality (VR), augmented reality (AR), or mixed reality (MR) technology running on portable devices, such as tablets and/or headsets. However, such experiences typically require a user to either hold a device in his or her hands or wear an apparatus on his or her head (e.g., goggles). These methods can be uncomfortable or cumbersome for a large number of users.

### SUMMARY

Therefore, what is needed is an approach that combines 3D projection and real-time 3D computer vision technologies to provide a completely immersive visual 3D experience that does not require a tablet or goggles, and also does not restrict the viewer's movement. The techniques described herein provide the advantage of rapidly capturing a scene and/or object(s) within the scene as a 3D model, recognizing the features in the scene/of the object(s), and seamlessly superimposing a rendered image into the scene or onto the object(s) using 3D projection methods. The techniques also provide the advantage of tracking the pose of the object(s)/scene to accurately superimpose the rendered image, even where the object(s), scene, and/or the projector are moving.

The invention, in one aspect, features a method for augmented reality in real-time using 3D projection techniques. A 3D sensor coupled to a computing device captures one or more scans of a physical object in a scene. The computing device generates one or more 3D models of the physical object based upon the one or more scans. The computing device determines a pose of the one or more 3D models relative to a projector at the scene. The computing device predistorts image content based upon the pose of the one or more 3D models to generate a rendered image map and a calibration result. A projector coupled to the computing device superimposes the rendered image map onto the physical object in the scene using the calibration result.

The invention, in another aspect, features a system for augmented reality in real-time using 3D projection techniques. The system comprises a computing device coupled to one or more 3D sensors and one or more projectors. At least one of the 3D sensors captures one or more scans of a physical object in a scene. The computing device generates one or more 3D models of the physical object based upon the one or more scans. The computing device determines a pose of the one or more 3D models relative to a projector at the scene. The computing device predistorts image content based upon the pose of the one or more 3D models to generate a rendered image map and a calibration result. At least one of the projectors superimposes the rendered image map onto the physical object in the scene using the calibration result.

Any of the above aspects can include one or more of the following features. In some embodiments, the 3D sensor captures the one or more scans in real time and streams the captured scans to the computing device. In some embodiments, the computing device updates the 3D models of the physical object as each scan is received from the 3D sensor. In some embodiments, the 3D models of the physical object are generated by the computing device using a simultaneous location and mapping technique.

In some embodiments, the image content comprises live video, animation, still images, or line drawings. In some embodiments, the step of predistorting image content comprises generating a registered 3D context based upon the 3D models, where the registered 3D context is represented in world coordinates of the 3D sensor; rotating and translating the registered 3D context from the world coordinates of the 3D sensor to world coordinates of the projector using calibration parameters; projecting the rotated and translated registered 3D context to 2D image coordinates; and rendering a 2D image map based upon the projected 2D image coordinates. In some embodiments, the calibration parameters include intrinsic parameters of the 3D sensor, intrinsic parameters of the projector, and extrinsic parameters of depth sensor to projector.

In some embodiments, the computing device automatically renders an updated image map for projection onto the physical object based upon movement of the physical object in the scene. In some embodiments, movement of the physical object in the scene comprises rotation, change of location, or change of orientation. In some embodiments, the computing device automatically renders an updated image map for projection onto the physical object based upon movement of the projector in relation to the physical object.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for augmented reality using 3D depth sensor and 3D projection techniques.

FIG. 2 is a flow diagram of a method for augmented reality using 3D depth sensor and 3D projection techniques.

FIG. 3 is a flow diagram of a method for pre-distorting image content based upon the pose of a scene and/or objects in the scene.

FIG. 4 is an exemplary registered context, the top surface of a 3D rectangular object.

FIG. 5 depicts the rotation and translation of the registered context from the 3D depth sensor world coordinates to the projector world coordinates

FIG. 6 depicts an exemplary 3D projection of a measurement of an object onto the object itself.

FIG. 7 depicts an exemplary 3D projection of an image onto an object in a scene as the projector moves around in the scene.

FIG. 8 depicts an exemplary 3D projection of live video onto an object in a scene as the object moves around in the scene.

### DETAILED DESCRIPTION

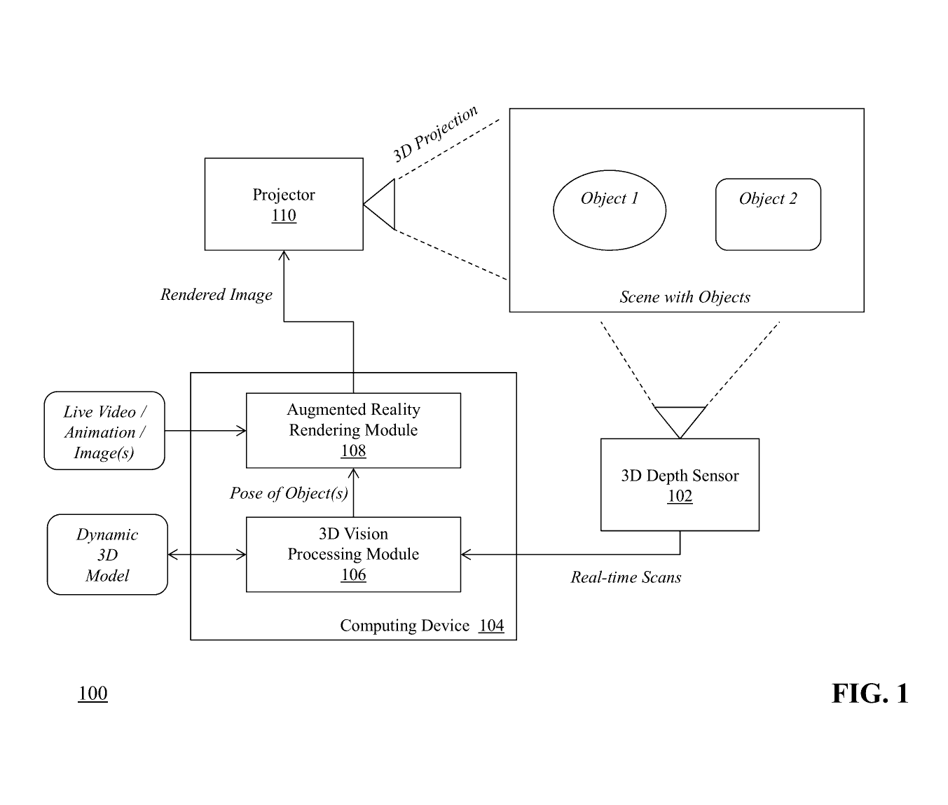

FIG. 1 is a block diagram of a system 100 for augmented reality using 3D depth sensor and 3D projection techniques. The system 100 includes a 3D depth sensor 102 (e.g., a 3D camera), a computing device 104 with a 3D vision processing module 106 and an augmented reality rendering module 108 executing on a processor, and a projector 110. In some embodiments, the projector is a 2D projector and in other embodiments, the projector is a 3D projector. The 3D depth sensor 102 operates to capture real-time 3D scans of a scene and/or object(s) within the scene.

The computing device 104 includes a processor and a memory, and comprises a combination of hardware and software modules for providing augmented reality in real-time using three-dimensional (3D) depth sensor and 3D projection techniques in conjunction with the other components of the system 100. The computing device 104 includes a 3D vision processing module 106 and an augmented reality rendering module 108. The modules 106, 108 are hardware and/or software modules that reside on the computing device 104 to perform functions associated with providing augmented reality in real-time using three-dimensional (3D) depth sensor and 3D projection techniques.

As will be explained in greater detail below, the 3D vision processing module 106 receives real-time 3D scans of the scene and/or object(s) from the 3D depth sensor 102. The 3D vision processing module 106 also generates a dynamic 3D model of the scene/object(s) as it receives scans from the sensor 102 and uses the dynamic 3D model as input to the 3D vision processing described herein. An exemplary computer vision library to be used in the 3D vision processing module 106 is the Starry Night library, available from VanGogh Imaging, Inc. of McLean, Virginia. The 3D vision processing module incorporates the 3D vision processing techniques as described in U.S. patent application Ser. No. 14/324,891, titled “Real-time 3D Computer Vision Processing Engine for Object Recognition, Reconstruction, and Analysis,” filed on Jul. 7, 2014, as described in U.S. patent application Ser. No. 14/849,172, titled “Real-time Dynamic Three-Dimensional Adaptive Object Recognition and Model Reconstruction,” filed on Sep. 9, 2015, and as described in U.S. patent application Ser. No. 14/954,775, titled “Closed-Form 3D Model Generation of Non-Rigid Complex Objects from Incomplete and Noisy Scans,” filed on Nov. 30, 2015, each of which is incorporated by reference herein.

As will be described in greater detail below, the augmented reality rendering module 108 receives information relating to the dynamic 3D model, including the pose of the scene/object(s) in the scene relative to the projector, from the 3D vision processing module 106. The augmented reality rendering module 108 also receives image content (e.g., still images or graphics, live video, animation, and the like) as input from an external source, such as a camera, an image file, a database, and so forth. The augmented reality rendering module 108 pre-distorts the image content using the relative pose received from the 3D vision processing module 106, in order to generate rendered image content (e.g., an image map) that can accurately be projected onto the scene/object(s) in the scene.

The projector 110 is a hardware device that receives the rendered image content from the augmented reality rendering module 108 and projects the rendered image content onto the scene/object(s) in the scene to create an augmented reality, mixed reality, and/or virtual reality effect. In some embodiments, the projector 110 is capable of projecting color images onto the scene/object(s), and in some embodiments the projector 110 is a laser projector that can project laser-based images (e.g., line drawings) onto the scene/object(s).

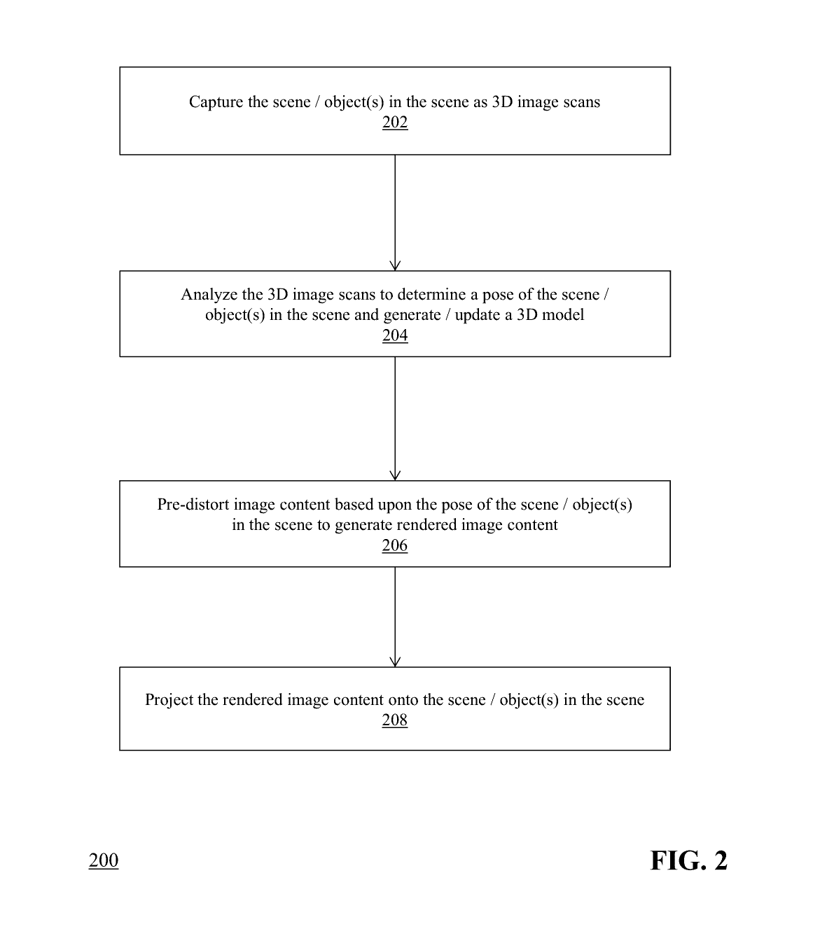

FIG. 2 is a flow diagram of a method 200 for augmented reality using 3D depth sensor and 3D projection techniques, using the system 100 of FIG. 1. The 3D depth sensor 102 captures (202) 3D image scans of a scene and/or object(s) included in the scene. The 3D depth sensor 102 transmits a stream of the 3D image scans, preferably in real-time, to the 3D vision processing module 106 of computing device 104. The 3D vision processing module 106 analyzes (204) the 3D image scans received from the sensor 102 to determine a pose of the scene and/or object(s) in the scene relative to the sensor 102. The 3D vision processing module 106 also generates a dynamic 3D model of the scene and/or object(s) in the scene using the 3D image scans and, as more scans are received, the module 106 updates the dynamic 3D model accordingly. Also, because the 3D depth sensor 102 is registered to the projector 110, the 3D vision processing module 106 can quickly determine the pose of the scene and/or object(s) in the scene relative to the projector 110. In some embodiments, the module 106 generates the dynamic 3D model at the same time as it receives and analyzes the 3D image scans from the sensor 102 using a technique such as Simultaneous Location and Mapping (SLAM), as described in U.S. patent application Ser. No. 14/324,891.

The 3D vision processing module 106 transmits the pose of the scene and/or object(s) in the scene, relative to the projector 110, to the augmented reality rendering module 108. The augmented reality rendering module 108 also receives, from an external source, image content that is intended to be projected onto the scene and/or the object(s) in the scene. Exemplary image content can include, but is not limited to, live video, animation, still images, line drawings, and the like. The image content can be in color and/or black-and-white.

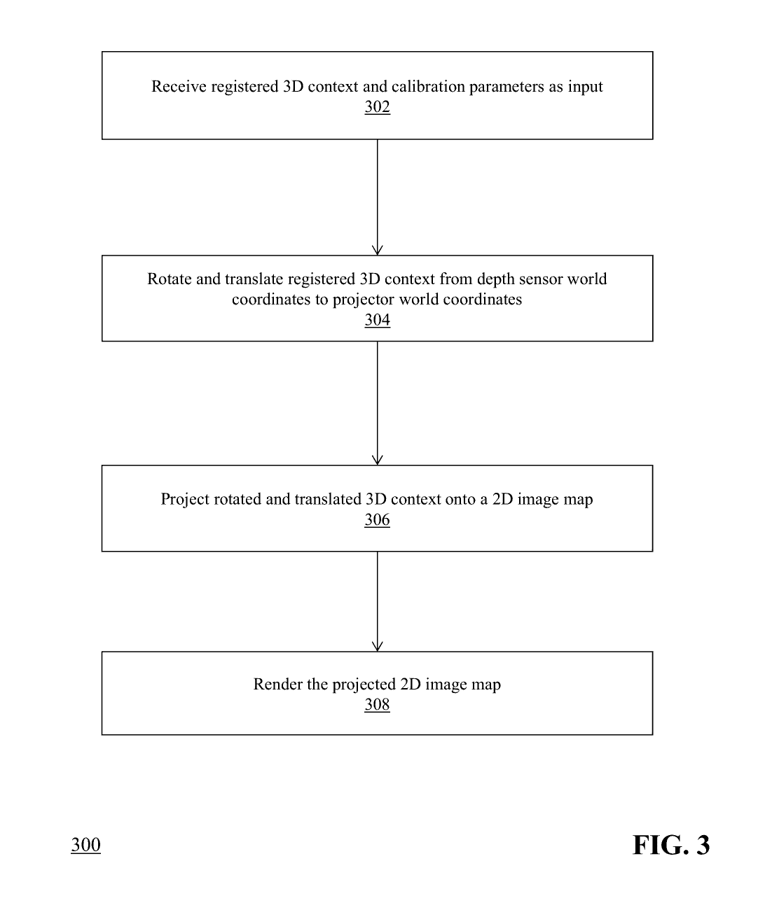

The augmented reality rendering module 108 pre-distorts (206) the received image content based upon the pose of the scene and/or object(s) in the scene, relative to the projector 110, as received from the 3D vision procession module 106—to generate rendered image content. A detailed explanation of the image rendering process performed by the augmented reality rendering module 108 is provided below, with respect to FIG. 3.

Continuing with FIG. 2, once the pre-distort process is complete, the augmented reality rendering module 108 transmits the rendered image content to the projector 110. The projector 110 projects the rendered image content onto the scene and/or object(s) in the scene to create an augmented reality, mixed reality, and/or virtual reality effect for an observer viewing the scene/object(s) in the scene.

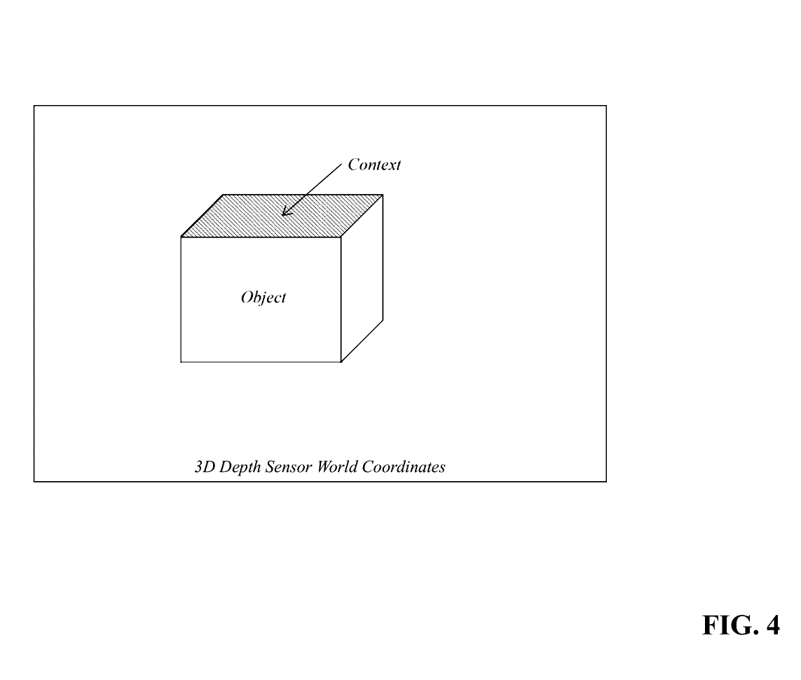

FIG. 3 is a flow diagram of a method 300 for pre-distorting image content based upon the pose of a scene and/or objects in the scene, using the system 100 of FIG. 1. The augmented reality rendering module 108 receives (302) a registered 3D context and calibration parameters as input. In some embodiments, the registered 3D context is the 3D model(s) generated by the 3D vision processing module 106 that is/are registered to the 3D scans as received from the 3D depth sensor 102. The registered 3D context is represented in world coordinates of the 3D depth sensor 102. An exemplary registered context is shown in FIG. 4, the top surface of a 3D rectangular object (shown as shaded in the figure). The calibration parameters include (i) intrinsic parameters of the 3D depth sensor—f^{D}ₓ, f^{D}_{y}, o^{D}ₓ, and o^{D}_{y}, (ii) intrinsic parameters of the projector—f^{P}ₓ, f^{P}_{y}, o^{P}ₓ, and o^{P}_{y}, and (iii) extrinsic parameters of depth sensor to projector—R and T.

The augmented reality rendering module 108 rotates and translates (304) the registered 3D context from the 3D depth sensor world coordinates to the projector world coordinates, using the extrinsic parameters R and T. Because the world coordinates of the 3D depth sensor 102 are different from the world coordinates of the projector 110, the augmented reality rendering module 108 can use the extrinsic parameters to align the registered 3D context from sensor world coordinates to the projector world coordinates, as shown in the following equation.

Let (x^{D}, y^{D}, z^{D}) be a 3D point of the registered 3D context in the sensor world coordinates and (x^{P}, y^{P}, z^{P}) be the same 3D point of the registered 3D context in the projector world coordinates. Then:

(x^{P}, y^{P}, z^{P})=R(x^{D}, y^{D}, z^{D})+T

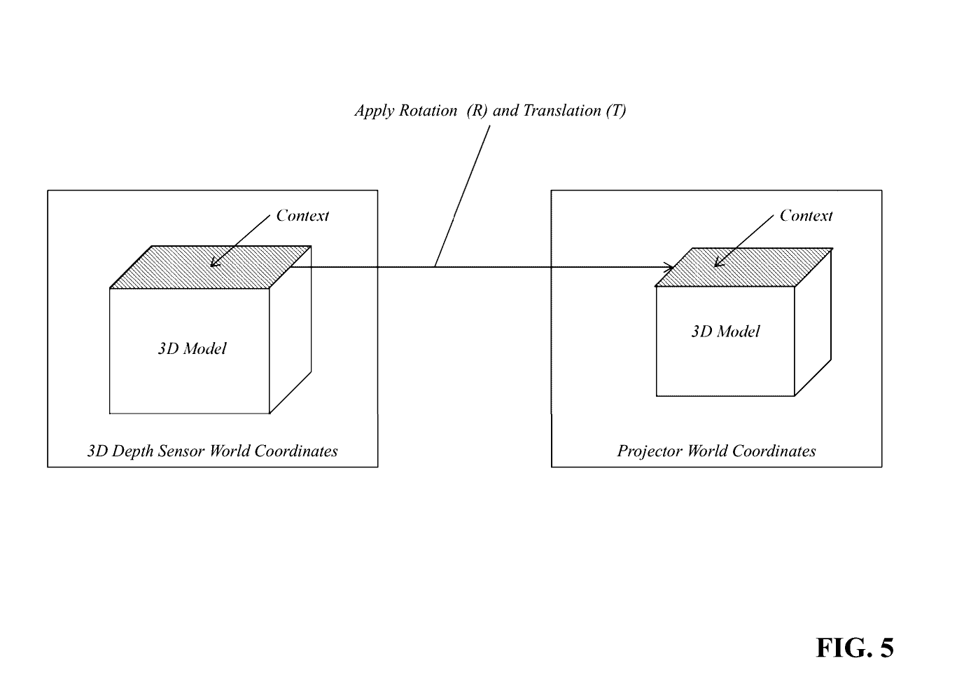

FIG. 5 depicts the rotation and translation of the registered context from the 3D depth sensor world coordinates to the projector world coordinates. The registered context is shown as shaded in the figure.

Next, in order to generate a 2D image map so that the projector 110 can superimpose the registered context accurately into the real-world scene and/or object(s), the augmented reality rendering module 108 projects (306) (also called back-projection) the registered 3D context in the projector world coordinates to 2D image coordinates for the projector. To back-project a 3D point from the projector world coordinates to projector 2D image coordinates, the following equations are used.

Let (x^{P}, y^{P}, z^{P}) be a 3D point of the registered 3D context in the projector world coordinates, and let (c^{P}, r^{P}) be the row and column of the same 3D point in the projector 2D image map. Then:

c^{P}=f^{P}ₓ*x^{P}z^{P}−o^{P}ₓ

and

r^{P}=f^{P}_{y}*y^{P}−o^{P}_{y}

Next, the augmented reality rendering module 108 renders (308) the projected 2D image map. For example, the module 108 can use a rendering algorithm such as Phong shading, or other similar techniques, to render the 2D image map. The rendered image map is then transmitted to the projector 110, which superimposes the image onto the scene and/or object(s) in the scene.

The following are exemplary augmented reality projections that can be accomplished using the techniques described herein.

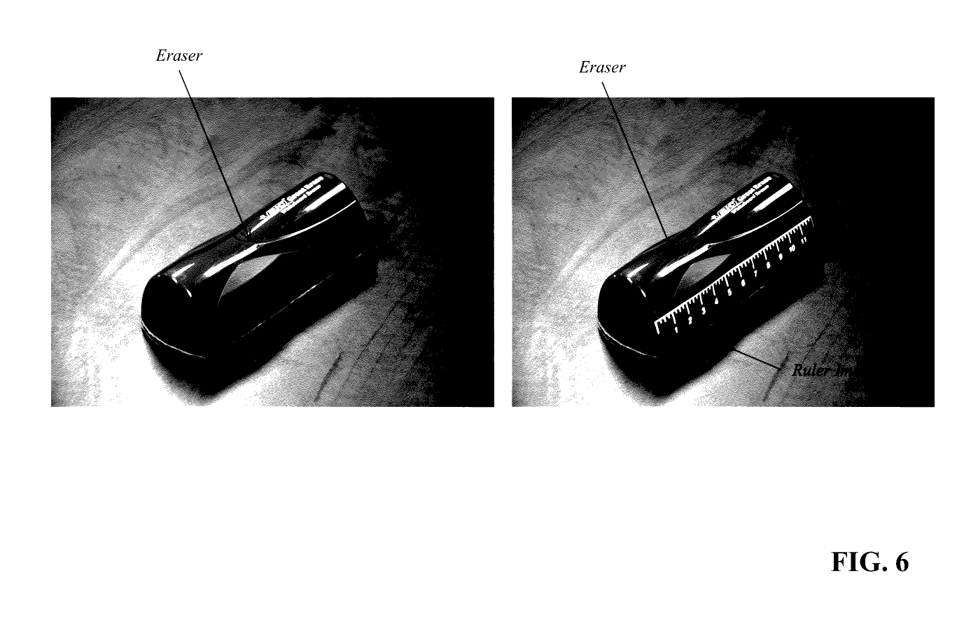

FIG. 6 depicts an exemplary 3D projection of a measurement of an object onto the object itself. As shown in the left-hand image in FIG. 6, an object (i.e., an eraser) is placed on a table in a scene. The system and method described above can be used to capture 3D scans of the eraser and analyze the scans to determine a measurement (e.g., length) of the eraser. For example, the 3D vision processing module 106 generates a 3D model of the eraser based upon scans from sensor 102, and the module 106 performs calculations on the model to determine the length of the eraser. The augmented reality rendering module 108 can generate image content that is representative of the measurement (e.g., a ruler image) and pre-distort the image content based upon the pose of the eraser relative to the projector, as explained previously. The projector 110 can then superimpose the rendered image content, namely the ruler image, onto the eraser in the scene to provide a viewer with an accurate visual display of the length of the ruler—directly onto the ruler itself—as shown in the right-hand image in FIG. 6.

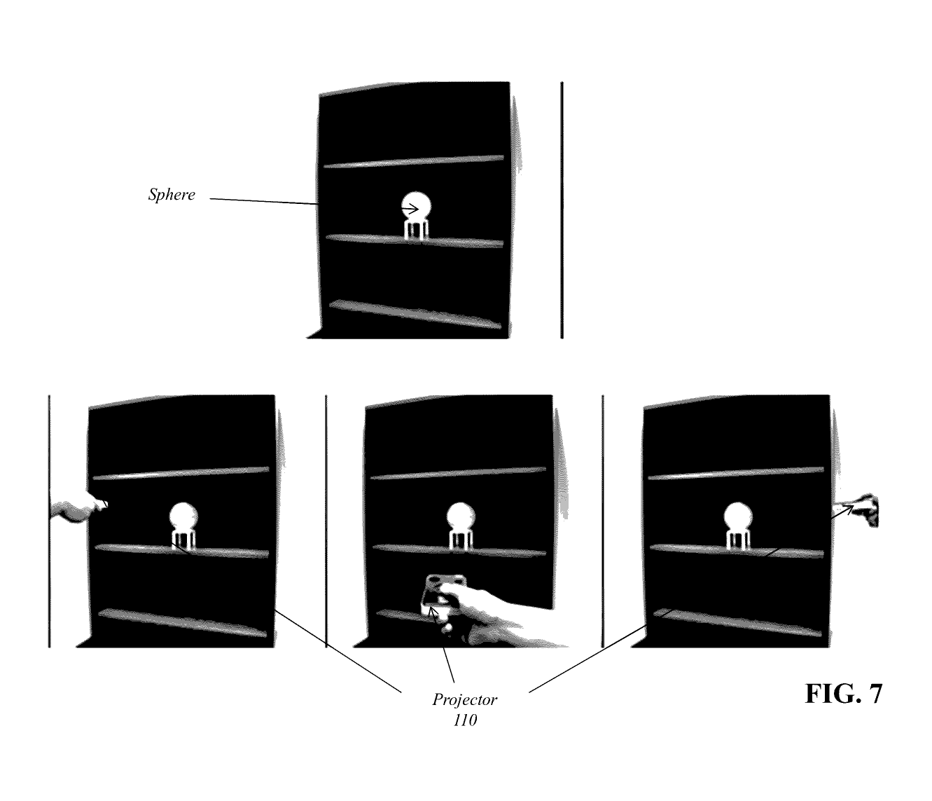

FIG. 7 depicts an exemplary 3D projection of an image onto an object in a scene as the projector moves around in the scene. As shown in the top image of FIG. 7, an object (i.e., a sphere) sits on a display stand in a bookshelf. The system and method described above can be used to capture 3D scans of the sphere and project an image (e.g., a globe) onto the sphere, even when the projector moves around the scene. For example, the 3D vision processing module 106 receives scans of the sphere and the scene from the 3D sensor 102 and generates a 3D model of the sphere, including the relative pose of the sphere with respect to the projector 110. The augmented reality rendering module 108 pre-distorts a predefined globe image based upon the relative pose, using the techniques described previously, and transmits the rendered globe image to the projector 110. The projector 110 superimposes the globe image onto the sphere, as shown in the bottom three images of FIG. 7. Also, as shown in the bottom three images of FIG. 7, as the projector 110 is repositioned with respect to the sphere and scene (e.g., moving from left to center to right), the system 100 adjusts the 3D model of the sphere and the pre-distortion of the globe image (based upon subsequent scans of the sphere received from the 3D sensor 102) and generates an updated rendered image to superimpose on the sphere.

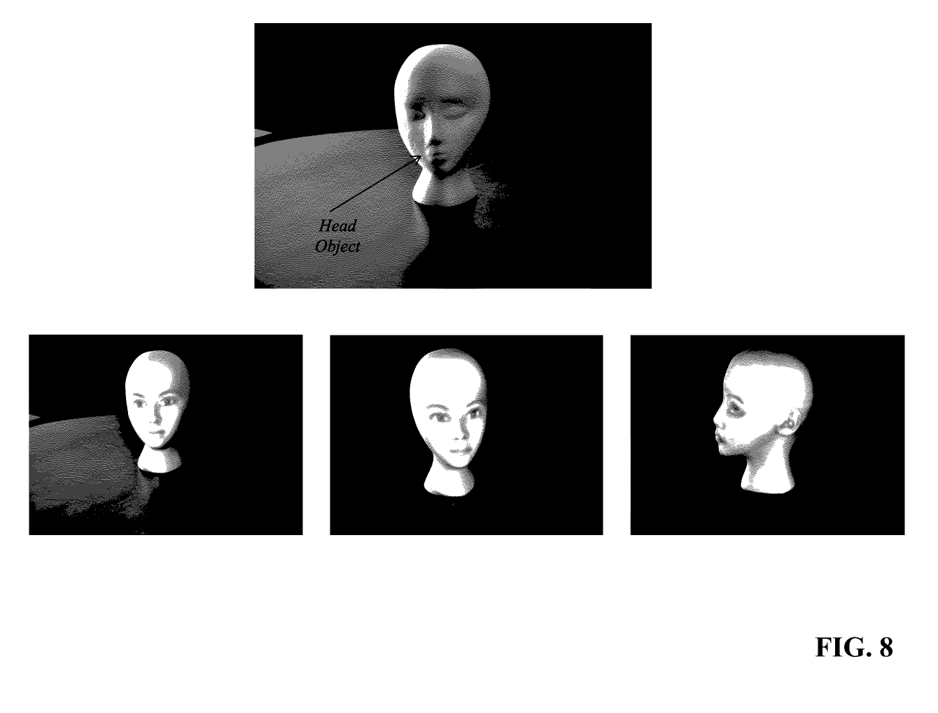

FIG. 8 depicts an exemplary 3D projection of live video onto an object in a scene as the object moves around in the scene. As shown in the top image of FIG. 8, an object shaped like a human head is placed on a table in the scene. The system and method described above can be used to capture 3D scans of the head object and project an image (e.g., live video of a person speaking) onto the head object, even when the head object moves around the scene. For example, the 3D vision processing module 106 receives scans of the head object and the scene from the 3D sensor 102 and generates a 3D model of the head object, including the relative pose of the sphere with respect to the projector 110. The augmented reality rendering module 108 receives live video of a person speaking (e.g., from a video camera) and pre-distorts the live video based upon the relative pose of the head object, using the techniques described previously, and transmits the rendered globe image to the projector 110. The projector 110 superimposes the video of the person speaking onto the sphere, as shown in the bottom three images of FIG. 8, so that the facial features and orientation of the person match the same features and orientation on the head object. Also, as shown in the bottom three images of FIG. 8, as the head object is repositioned with respect to the projector and scene (e.g., rotating from side to side), the system 100 adjusts the 3D model of the head object and the pre-distortion of the live video (based upon subsequent scans of the head object received from the 3D sensor 102) and generates an updated rendered image to superimpose on the head object—all while maintaining the accuracy of the projection onto the object.

It should be appreciated that the techniques described herein can be used to provide augmented reality projections onto scenes and/or object(s) where both the scene/object(s) and the projector are moving—thereby creating a dynamic 3D image generation and projection methodology that is applicable to any number of technical fields, including the examples described below.

Gaming—the method and system described herein can render high-resolution 3D graphics and videos onto objects as well as onto a scene. For example, the system can turn everyday objects into fancy medieval weapons or give an ordinary living room the appearance of a throne room inside of a castle.

Education—the method and system described herein can superimpose images onto real-world objects, such as an animal, to superimpose educational information like the names of the animal's body parts or project images of internal organs onto the appropriate locations of the animal's body—even if the animal is moving.

Parts inspection—the method and system described herein can highlight the location of defects on various parts, e.g., of an apparatus or a machine, directly on the part relative to what a non-defective part should look like. For example, if a part is broken or missing a piece, the method and system can superimpose a non-defective part directly onto the broken part to show a supervisor or repairperson precisely where the defect is (including the use of different colors—e.g., red for missing pieces) and what the intact part should look like.

Training—the method and system described herein can show a new employee how to assemble an apparatus step-by-step, even if the apparatus has multiple pieces, or show a person how to fix broken items. For example, the system can project 3D images of the parts used to assemble the apparatus in a manner that makes the parts appear as they would be in front of the user—and then move the parts around the scene to show the user how the parts fit together.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method for augmented reality in real-time using 3D projection techniques, the method comprising:
capturing, by a 3D sensor coupled to a computing device, one or more scans of a physical object in a scene;
generating, by the computing device, one or more 3D models of the physical object based upon the one or more scans;
determining, by the computing device, a pose of the one or more 3D models relative to a projector at the scene;
predistorting, by the computing device, image content based upon the pose of the one or more 3D models to generate a rendered image map and a calibration result; and
superimposing, by a projector coupled to the computing device, the rendered image map onto the physical object in the scene using the calibration result.

2. The method of claim 1, wherein the 3D sensor captures the one or more scans in real time and streams the captured scans to the computing device.

3. The method of claim 1, further comprising updating, by the computing device, the 3D models of the physical object as each scan is received from the 3D sensor.

4. The method of claim 1, wherein the 3D models of the physical object are generated by the computing device using a simultaneous location and mapping technique.

5. The method of claim 1, wherein the image content comprises live video, animation, still images, or line drawings.

6. The method of claim 1, wherein the step of predistorting image content comprises:
generating, by the computing device, a registered 3D context based upon the 3D models, wherein the registered 3D context is represented in world coordinates of the 3D sensor;
rotating and translating, by the computing device, the registered 3D context from the world coordinates of the 3D sensor to world coordinates of the projector using calibration parameters;
projecting, by the computing device, the rotated and translated registered 3D context to 2D image coordinates; and
rendering, by the computing device, a 2D image map based upon the projected 2D image coordinates.

7. The method of claim 6, wherein the calibration parameters include intrinsic parameters of the 3D sensor, intrinsic parameters of the projector, and extrinsic parameters of depth sensor to projector.

8. The method of claim 1, wherein the computing device automatically renders an updated image map for projection onto the physical object based upon movement of the physical object in the scene.

9. The method of claim 8, wherein movement of the physical object in the scene comprises rotation, change of location, or change of orientation.

10. The method of claim 1, wherein the computing device automatically renders an updated image map for projection onto the physical object based upon movement of the projector in relation to the physical object.

11. A system for augmented reality in real-time using 3D projection techniques, the system comprising:
one or more 3D sensors configured to capture one or more scans of a physical object in a scene;
a computing device configured to:
generate one or more 3D models of the physical object based upon the one or more scans;
determine a pose of the one or more 3D models relative to the projector; and
predistort image content based upon the pose of the one or more 3D models to generate a rendered image map and a calibration result; and
one or more projectors configured to superimpose the rendered image map onto the physical object in the scene using the calibration result.

12. The system of claim 11, wherein the 3D sensor captures the one or more scans in real time and streams the captured scans to the computing device.

13. The system of claim 11, wherein the computing device is further configured to update the 3D models of the physical object as each scan is received from the 3D sensor.

14. The system of claim 11, wherein the computing device generates the 3D models of the physical object using a simultaneous location and mapping technique.

15. The system of claim 11, wherein the image content comprises live video, animation, still images, or line drawings.

16. The system of claim 11, wherein for the step of predistorting image content, the computing device is configured to:
generate a registered 3D context based upon the 3D models, wherein the registered 3D context is represented in world coordinates of the 3D sensor;
rotate and translate the registered 3D context from the world coordinates of the 3D sensor to world coordinates of the projector using calibration parameters;
project the rotated and translated registered 3D context to 2D image coordinates; and
render a 2D image map based upon the projected 2D image coordinates.

17. The system of claim 16, wherein the calibration parameters include intrinsic parameters of the 3D sensor, intrinsic parameters of the projector, and extrinsic parameters of depth sensor to projector.

18. The system of claim 11, wherein the computing device is configured to automatically render an updated image map for projection onto the physical object based upon movement of the physical object in the scene.

19. The system of claim 18, wherein movement of the physical object in the scene comprises rotation of the object, a change of location of the object, or a change of orientation of the object.

20. The system of claim 11, wherein the computing device is configured to automatically render an updated image map for projection onto the physical object based upon movement of the projector in relation to the physical object.
